(19) United States
(12) Patent Application Publication
(10) Pub. No.: US 2022/0234579 A1
(43) Pub. Date: Jul. 28, 2022

(54) METHOD FOR ADJUSTING VEHICLE-MOUNTED SURROUND-VIEW MODEL, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Changsen CHU, Beijing (CN); Daming LI, Beijing (CN); Gui HU, Beijing (CN); Yanyan WANG, Beijing (CN)

(21) Appl. No.: 17/721,799

(22) Filed: Apr. 15, 2022

(30) Foreign Application Priority Data
Aug. 27, 2021 (CN) 202111000386.2

(51) Int. Cl. B60W 30/095; G06V 20/58

(52) U.S. Cl. CPC B60W 30/095; G06V 20/58; B60W 2520/10; B60W 2554/4049; B60W 2420/42; B60W 2510/0638

(57) ABSTRACT

A method for adjusting a vehicle-mounted surround-view model includes acquiring the vehicle-mounted surround-view model; acquiring a lateral distance and a longitudinal distance between a vehicle and an obstacle; and adjusting the vehicle-mounted surround-view model based on the lateral distance and the longitudinal distance. An apparatus for adjusting a vehicle-mounted surround-view model includes an electronic device and a storage medium, and relates to the field of smart transportation, and in particular, to the field of automobiles.

### CROSS-REFERENCE TO RELATED APPLICATIONS

The present application claims the priority of Chinese Patent Application No. 202111000386.2, titled “METHOD AND APPARATUS FOR ADJUSTING VEHICLE-MOUNTED SURROUND-VIEW MODEL, ELECTRONIC DEVICE AND STORAGE MEDIUM”, filed on Aug. 27, 2021, the content of which is incorporated herein by reference in its entirety.

### TECHNICAL FIELD

Embodiments of the present disclosure relate to the technical field of smart transportation, and in particular to a method for adjusting a vehicle-mounted surround-view model, an electronic device and a storage medium in the field of automobiles.

### BACKGROUND

Since many scratches and collisions of cars occur in low-speed and complex road conditions, a vehicle-mounted panoramic surround-view system enables users to easily view obstacles around vehicles, reduce collisions between the vehicles and the obstacles, and improve the safety of vehicle traveling.

### SUMMARY

Embodiments of the present disclosure provide a method for adjusting a vehicle-mounted surround-view model, an electronic device and a storage medium.

In an aspect, embodiments of the present disclosure provide a method for adjusting a vehicle-mounted surround-view model, the method comprising:

acquiring the vehicle-mounted surround-view model;

acquiring a lateral distance and a longitudinal distance between a vehicle and an obstacle; and

adjusting the vehicle-mounted surround-view model based on the lateral distance and the longitudinal distance.

In another aspect, embodiments of the present disclosure provide an electronic device, which includes: at least one processor; and

a memory communicatively connected to the at least one processor; here,

the memory stores instructions executable by the at least one processor, and the instructions, when executed by the at least one processor, cause the at least one processor to perform the method for adjusting a vehicle-mounted surround-view model according to any one the embodiments in the above aspect.

In yet another aspect, embodiments of the present disclosure provide a non-transitory computer readable medium storing computer instructions, the computer instructions are used to cause the computer to perform the method for adjusting a vehicle-mounted surround-view model.

It should be understood that contents described in this section are neither intended to identify key or important features of embodiments of the present disclosure, nor intended to limit the scope of the present disclosure. Other features of the present disclosure will become readily understood in conjunction with the following description.

### BRIEF DESCRIPTION OF THE DRAWINGS

The accompanying drawings are used for better understanding of the present solution, and do not constitute a limitation to the present disclosure. In which:

FIG. 1 is a flowchart of a method for adjusting a vehicle-mounted surround-view model according to an embodiment of the present disclosure;

FIG. 2 is a schematic diagram of a vehicle-mounted surround-view model according to an embodiment of the present disclosure;

FIG. 3 is a front view of the vehicle-mounted surround-view model according to an embodiment of the present disclosure;

FIG. 4 is a left side view of the vehicle-mounted surround-view model according to an embodiment of the present disclosure;

FIG. 5 is a flowchart of a method for adjusting a vehicle-mounted surround-view model according to another embodiment of the present disclosure;

FIG. 6 is a flowchart of a method for adjusting a vehicle-mounted surround-view model according to yet another embodiment of the present disclosure;

FIG. 7 is a schematic diagram of an apparatus for adjusting a vehicle-mounted surround-view model according to an embodiment of the present disclosure;

FIG. 8 is a schematic diagram of an apparatus for adjusting a vehicle-mounted surround-view model according to another embodiment of the present disclosure;

FIG. 9 is a schematic diagram of an apparatus for adjusting a vehicle-mounted surround-view model according to yet another embodiment of the present disclosure; and

FIG. 10 is a block diagram of an electronic device used to implement the method for adjusting a vehicle-mounted surround-view model according to an embodiment of the present disclosure.

### DETAILED DESCRIPTION OF EMBODIMENTS

Example embodiments of the present disclosure are described below with reference to the accompanying drawings, where various details of the embodiments of the present disclosure are included to facilitate understanding, and should be considered merely as examples. Therefore, those of ordinary skills in the art should realize that various changes and modifications may be made to the embodiments described here without departing from the scope and spirit of the present disclosure. Similarly, for clearness and conciseness, descriptions of well-known functions and structures are omitted in the following description.

A vehicle-mounted panoramic surround-view system is a display system used to display surround-view images corresponding to surrounding environment of a vehicle. It photographs images by setting four ultra-large wide-angle fisheye cameras in the front, rear, left and right sides of the vehicle, and displays a spliced picture of the photographed images in a vehicle-mounted surround-view model with constant shape and size, to realize the display of the images of the surrounding environment of the vehicle, which is used to assist a driver to drive safely.

The picture photographed by the fisheye cameras is a flat image, and an obstacle photographed around the vehicle may be stretched in the vehicle-mounted surround-view model. Since a distance between the vehicle and the obstacle changes all the time when the vehicle is traveling at low speed, an image position and a size of the obstacle also change all the time, so that an obstacle image does not match the vehicle-mounted surround-view model. If the shape and size of the vehicle-mounted surround-view model remain unchanged, when using the same stretching method, the displayed position of the image of the obstacle may be inconsistent with an actual position, and the image of the obstacle displayed in the vehicle-mounted surround-view model may be severely distorted.

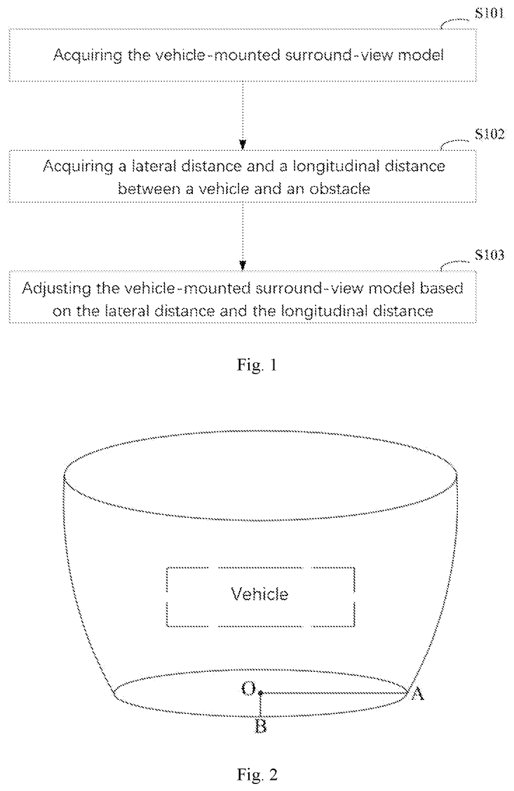

In order to solve the above problem, an embodiment of the present disclosure provides a method for adjusting a vehicle-mounted surround-view model. As shown in FIG. 1, the method includes:

Step S101, acquiring the vehicle-mounted surround-view model.

FIG. 2 illustrates a schematic diagram of a vehicle-mounted surround-view model according to an embodiment of the present disclosure, and the vehicle-mounted surround-view model is a flat-bottomed bowl-shaped model. The bowl-shaped model includes a bottom surface and a side surface. The bottom surface of the bowl-shaped model is an ellipse, where a major axis direction of the ellipse is parallel to a vehicle traveling direction, and a minor axis direction of the ellipse is perpendicular to the vehicle traveling direction; a shape and size of the side surface of the bowl-shaped model remain unchanged, so a width of the side surface in the horizontal direction is a fixed value. A projection center of the vehicle on the ground is a center of the bottom surface of the bowl-shaped model, and the shape and size of the vehicle-mounted surround-view model depend on a length of a major semi-axis and a length of a minor semi-axis of the ellipse bottom surface. If the length of the major semi-axis is the same as the length of the minor semi-axis, the bottom surface of the bowl-shaped model is circular. The projection center point O of the vehicle on the ground is the center of the bottom surface of the bowl-shaped model, OA is the major semi-axis of the ellipse bottom surface, and OB is the minor semi-axis of the ellipse bottom surface.

Step S102, acquiring a lateral distance and a longitudinal distance between a vehicle and an obstacle.

During traveling of the vehicle, pedestrians, moving objects, motor vehicles, non-motor vehicles, road piles, stone piers, etc. around the vehicle are all obstacles for the traveling vehicle, obstacles in a blind area of the driver's field of vision may especially affect normal traveling of the vehicle. For example, there may be scratches, collisions between the vehicle and the obstacles, and even traffic accidents in severe cases. Therefore, when an obstacle appears near the vehicle, the driver needs to take emergency measures according to an obstacle image in the vehicle-mounted surround-view model, to improve the safety of the driving.

A relative position between the vehicle and the projection center on the ground remains unchanged during traveling of the vehicle. Therefore, in an example, the projection center of the vehicle on the ground is used as a reference point of the vehicle, a direction perpendicular to the vehicle traveling direction is the lateral direction, and a direction parallel to the vehicle traveling direction is the longitudinal direction. A lateral distance between the obstacle and the projection center indicates the lateral distance between the obstacle and the vehicle, and a longitudinal distance between the obstacle and the projection center indicates the longitudinal distance between the obstacle and the vehicle.

The lateral distance and the longitudinal distance between the vehicle and the obstacle may be obtained by setting a binocular camera on the vehicle, photographing pictures of the obstacle using the binocular camera, and processing the photographed pictures of the obstacle to calculate the lateral distance and the longitudinal distance between the vehicle and the obstacle. The lateral distance and the longitudinal distance between the vehicle and the obstacle may also be determined by radar ranging, and methods such as distance sensors and laser ranging may also be used. The present disclosure does not limit a method for detecting the lateral distance and the longitudinal distance.

Step S103, adjusting the vehicle-mounted surround-view model based on the lateral distance and the longitudinal distance.

In an example, the adjusting the vehicle-mounted surround-view model based on the lateral distance and the longitudinal distance includes:

determining a lateral length and a longitudinal length of the adjusted vehicle-mounted surround-view model based on the lateral distance and the longitudinal distance.

When the lateral length and the longitudinal length of the vehicle-mounted surround-view model are changed, the size of the vehicle-mounted surround-view model changes. Therefore, the vehicle-mounted surround-view model may be adjusted by adjusting the lateral length and the longitudinal length of the vehicle-mounted surround-view model.

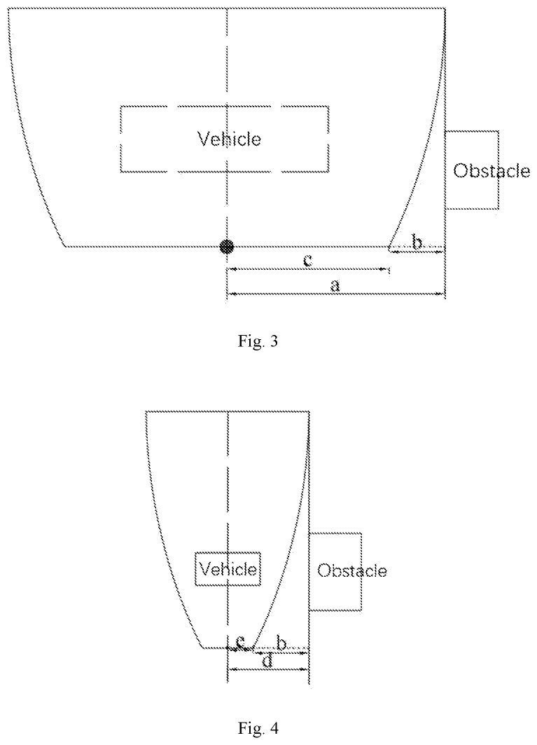

In order to make the image of the obstacle always match the vehicle-mounted surround-view model, it is necessary to make the actual position of the obstacle always coincide with the side surface of the vehicle-mounted surround-view model, and a rear direction of the vehicle is a front view direction. FIG. 3 illustrates a front view of the vehicle-mounted surround-view model according to an embodiment of the present disclosure. For the convenience of description, the lateral distance between the obstacle and the projection center is denoted as a, the width of the side surface of the bowl-shaped model in the lateral direction is denoted as b, and the length of the minor semi-axis of the bowl-shaped model is denoted as c, so it may be obtained that:

a=b+c (1)

FIG. 4 illustrates a left side view of the vehicle-mounted surround-view model according to an embodiment of the present disclosure. For the convenience of description, the longitudinal distance between the obstacle and the projection center is denoted as d, and the length of the major semi-axis of the bowl-shaped model is denoted as e, so it may be obtained that:

d=b+e (2)

The lateral distance and the longitudinal distance between the vehicle and the obstacle are changing all the time during traveling of the vehicle, that is, the lateral distance a between the obstacle and the projection center and the longitudinal distance d between the obstacle and the projection center change all the time. According to the above formulas (1) and (2), since the width b of the side surface of the bowl-shaped model in the lateral direction is a fixed value, if a and d change, c and e may also change synchronously. According to the above formulas (1) and (2), it may be obtained that:

c=a−b (3)

e=d−b (4)

According to the formulas (3) and (4), the length of the minor semi-axis and the length of the major semi-axis of the bottom surface of the bowl-shaped model may be determined. The length of the minor semi-axis of the bottom surface of the bowl-shaped model is the lateral length of the adjusted vehicle-mounted surround-view model, and the length of the major semi-axis of the bottom surface of the bowl-shaped model is the longitudinal length of the adjusted vehicle-mounted surround-view model.

The present disclosure adjusts the vehicle-mounted surround-view model based on the lateral distance and the longitudinal distance between the vehicle and the obstacle, thus the vehicle-mounted surround-view model is a dynamic model that changes as the vehicle moves, so that the image of the obstacle matches the vehicle-mounted surround-view model.

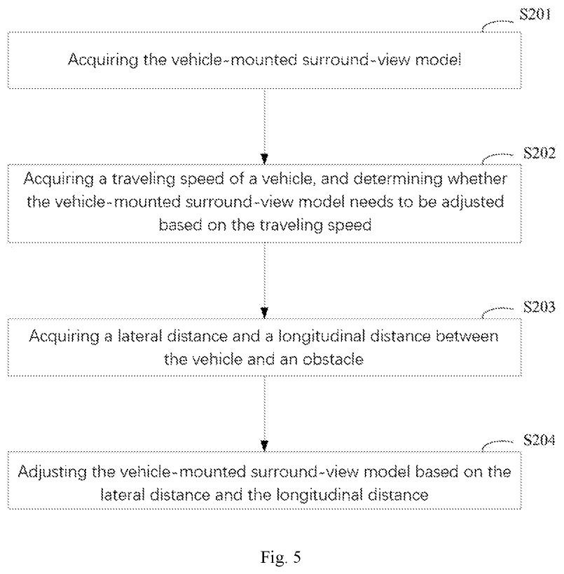

In an example, another embodiment of the present disclosure provides a method for adjusting a vehicle-mounted surround-view model, as shown in FIG. 5, the method includes:

Step S201, acquiring the vehicle-mounted surround-view model.

Step S201 is the same as the above step S101, and detailed description thereof will be omitted in the present disclosure.

Step S202, acquiring a traveling speed of a vehicle, and determining whether the vehicle-mounted surround-view model needs to be adjusted based on the traveling speed.

The traveling speed of the vehicle may be a traveling speed output by the vehicle itself. For example, the traveling speed of the vehicle may be displayed synchronously on a vehicle dashboard in real time; the traveling speed of the vehicle may also be acquired by setting a speed sensor on the vehicle, and the speed sensor acquires the traveling speed of the vehicle, which is not limited in the present disclosure.

By acquiring the traveling speed of the vehicle, it can be determined whether the vehicle is in a traveling state or a stationary state, so as to further determine whether the vehicle-mounted surround-view model needs to be adjusted.

In an example, the determining whether the vehicle-mounted surround-view model needs to be adjusted based on the traveling speed, includes:

adjusting the vehicle-mounted surround-view model, if the traveling speed is greater than a preset threshold.

For example, the preset threshold is 0. When the traveling speed is greater than 0, that is, the vehicle is in a traveling state, and the vehicle-mounted surround-view model needs to be adjusted in this regard. When the vehicle is stationary, the traveling speed is 0. If the obstacle is stationary, the lateral distance and the longitudinal distance between the vehicle and the obstacle have not changed, so there is no need to adjust the lateral distance and the longitudinal distance between the vehicle and the obstacle. If the obstacle is dynamic, although the lateral distance and the longitudinal distance between the vehicle and the obstacle change, the driver does not need to take corresponding emergency measures according to the image of the obstacle because the vehicle is stationary, so there is no need to adjust the vehicle-mounted surround-view model.

Step S203, acquiring a lateral distance and a longitudinal distance between the vehicle and an obstacle.

Step S204, adjusting the vehicle-mounted surround-view model based on the lateral distance and the longitudinal distance.

The present disclosure takes a vehicle speed condition into consideration, and aims to prevent the driver from feeling discomfort due to changes in video picture during state adjustment of the vehicle-mounted surround-view model when the vehicle is stationary. The distance between the vehicle and the obstacle changes all the time during the traveling of the vehicle, therefore, the present disclosure adjusts the vehicle-mounted surround-view model, so that the image of the obstacle matches the adjusted vehicle-mounted surround-view model.

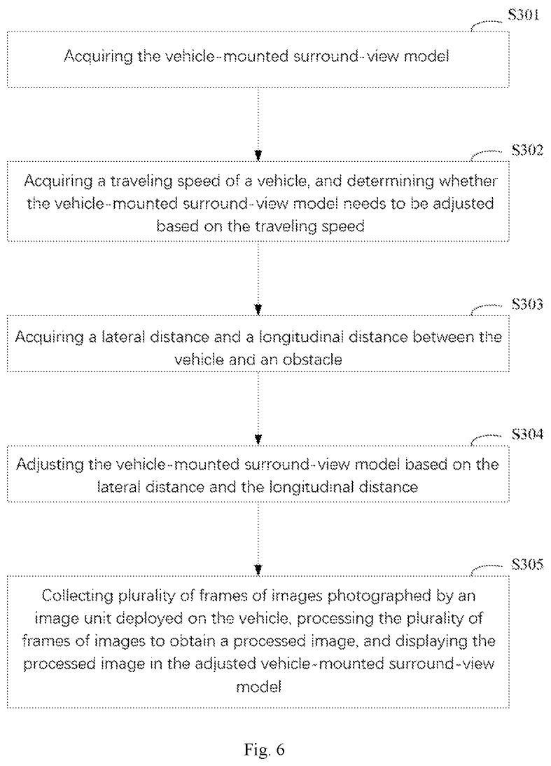

In an example, yet another embodiment of the present disclosure provides a method for adjusting a vehicle-mounted surround-view model, as shown in FIG. 6, the method includes:

Step S301, acquiring the vehicle-mounted surround-view model.

Step S302, acquiring a traveling speed of a vehicle, and determining whether the vehicle-mounted surround-view model needs to be adjusted based on the traveling speed.

Step S303, acquiring a lateral distance and a longitudinal distance between the vehicle and an obstacle.

Step S304, adjusting the vehicle-mounted surround-view model based on the lateral distance and the longitudinal distance.

Steps S301 to S304 are the same as the above steps S201 to S204, and detailed description thereof will be omitted in the present disclosure.

After adjusting the vehicle-mounted surround-view model, the method further includes:

Step S305, collecting a plurality of frames of images photographed by an image unit deployed on the vehicle, processing the plurality of frames of images to obtain a processed image, and displaying the processed image in the adjusted vehicle-mounted surround-view model.

After the vehicle-mounted surround-view model is adjusted, it is also necessary to project surround-view images corresponding to surrounding environment of the vehicle onto the vehicle-mounted surround-view model to generate a surround-view stereo image of the surrounding environment of the vehicle, so as to realize the display of the surrounding environment image, so that the driver can intuitively see the environment around the vehicle. The image unit may be a plurality of fisheye cameras, and by deploying the plurality of fisheye cameras on the vehicle, the plurality of fisheye cameras can cover a 360° range around the vehicle.

In an example, the processing the plurality of frames of images to obtain a processed image, and displaying the processed image in the adjusted vehicle-mounted surround-view model, includes:

performing distortion correction on each frame of image separately;

transforming distortion-corrected images into a bird's-eye top view plane through bird's-eye perspective transformation to obtain bird's-eye-transformed images; and

performing texture mapping, splicing and visual transformation of the bird's-eye-transformed images on the adjusted vehicle-mounted surround-view model to obtain a panoramic surround-view image, and displaying the panoramic surround-view image in the adjusted vehicle-mounted surround-view model.

In an example, an ultra-wide-angle fisheye camera is set in the front, rear, left and right of the vehicle, respectively. These four fisheye cameras can cover a 360° range around the vehicle, for example, at a front license plate position, a rear license plate position, a left mirror position and a right mirror position of the vehicle. At the same time, the four fisheye cameras may photograph four frames of images, perform distortion correction on the four frames of images respectively, transform the distortion-corrected images into the bird's-eye top view plane through the bird's-eye perspective transformation to obtain the bird's-eye-transformed images; and perform texture mapping, splicing and visual transformation of the bird's-eye-transformed images on the adjusted vehicle-mounted surround-view model to obtain the panoramic surround-view image, and display the panoramic surround-view image in the adjusted vehicle-mounted surround-view model.

In the present disclosure, by adjusting the vehicle-mounted surround-view model, the adjusted vehicle-mounted surround-view model better matches the image of the obstacle, so that the panoramic surround-view image finally displayed in the vehicle-mounted surround-view model may not be distorted.

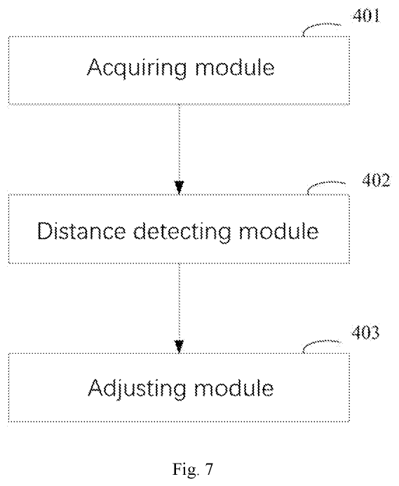

In an example, an embodiment of the present disclosure provides an apparatus for adjusting a vehicle-mounted surround-view model, as shown in FIG. 7, the apparatus includes:

an acquiring module 401, configured to acquire a vehicle-mounted surround-view model;

a distance detecting module 402, configured to acquire a lateral distance and a longitudinal distance between a vehicle and an obstacle; and

an adjusting module 403, configured to adjust the vehicle-mounted surround-view model based on the lateral distance and the longitudinal distance.

The present disclosure adjusts the vehicle-mounted surround-view model, thus the vehicle-mounted surround-view model is a dynamic model that changes as the vehicle moves, so that the image of the obstacle matches the vehicle-mounted surround-view model.

In an example, the adjusting module 403 is configured to: determine a lateral length and a longitudinal length of the adjusted vehicle-mounted surround-view model based on the lateral distance and the longitudinal distance.

When the lateral length and the longitudinal length of the vehicle-mounted surround-view model are changed, the size of the vehicle-mounted surround-view model changes. Therefore, the vehicle-mounted surround-view model may be adjusted by adjusting the lateral length and the longitudinal length of the vehicle-mounted surround-view model.

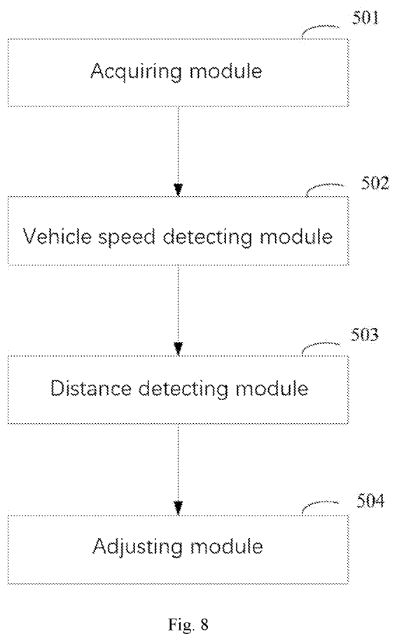

In an example, another embodiment of the present disclosure provides an apparatus for adjusting a vehicle-mounted surround-view model, as shown in FIG. 8, the apparatus includes:

An acquiring module 501, configured to acquire a vehicle-mounted surround-view model.

A vehicle speed detecting module 502, configured to determine whether the vehicle-mounted surround-view model needs to be adjusted based on the traveling speed.

The vehicle speed detecting module 502 is specifically configured to:

adjust the vehicle-mounted surround-view model, if the traveling speed is greater than a preset threshold. For example, the preset threshold is 0. When the traveling speed of the vehicle is greater than 0, it indicates that the vehicle is in a traveling state, and a distance between the vehicle and the obstacle changes all the time, so it is necessary to adjust the vehicle-mounted surround-view model. When the traveling speed is 0, the vehicle-mounted surround-view model is not adjusted. The purpose of not adjusting is to prevent the driver from feeling discomfort due to changes in video picture during state adjustment of the vehicle-mounted surround-view model when the vehicle is stationary.

A distance detecting module 503, configured to acquire a lateral distance and a longitudinal distance between a vehicle and an obstacle.

An adjusting module 504, configured to adjust the vehicle-mounted surround-view model based on the lateral distance and the longitudinal distance.

In the present disclosure, the vehicle speed detecting module determines whether the vehicle-mounted surround-view model needs to be adjusted, and then the distance detecting module acquires the lateral distance and the longitudinal distance between the vehicle and the obstacle, so as to adjust the vehicle-mounted surround-view model. The adjusted vehicle-mounted surround-view model better matches the image of the obstacle, so that the panoramic surround-view image finally displayed in the vehicle-mounted surround-view model may not be distorted.

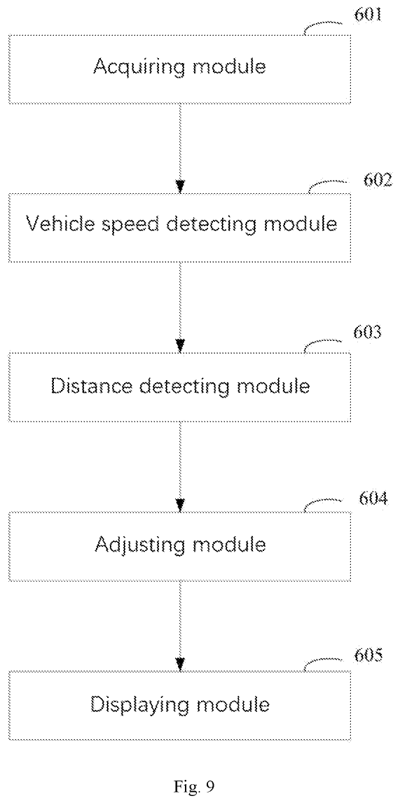

In an example, yet another embodiment of the present disclosure provides an apparatus for adjusting a vehicle-mounted surround-view model, as shown in FIG. 9, the apparatus includes:

An acquiring module 601, configured to acquire a vehicle-mounted surround-view model.

A vehicle speed detecting module 602, configured to determine whether the vehicle-mounted surround-view model needs to be adjusted based on the traveling speed.

A distance detecting module 603, configured to acquire a lateral distance and a longitudinal distance between a vehicle and an obstacle.

An adjusting module 604, configured to adjust the vehicle-mounted surround-view model based on the lateral distance and the longitudinal distance.

A displaying module 605, is configured to collect a plurality of frames of images photographed by an image unit deployed on the vehicle, process the plurality of frames of images to obtain a processed image, and displaying the processed image in the adjusted vehicle-mounted surround-view model.

After the vehicle-mounted surround-view model is adjusted, it is also necessary to project surround-view images corresponding to surrounding environment of the vehicle onto the vehicle-mounted surround-view model to generate a surround-view stereo image of the surrounding environment of the vehicle, so as to realize the display of the surrounding environment image, so that the driver can intuitively see the environment around the vehicle.

The displaying module 605 is configured to:

perform distortion correction on each frame of image separately;

transform distortion-corrected images into a bird's-eye top view plane through bird's-eye perspective transformation to obtain bird's-eye-transformed images; and

perform texture mapping, splicing and visual transformation of the bird's-eye-transformed images on the adjusted vehicle-mounted surround-view model to obtain a panoramic surround-view image, and display the panoramic surround-view image in the adjusted vehicle-mounted surround-view model.

In the present disclosure, by adjusting the vehicle-mounted surround-view model, the adjusted vehicle-mounted surround-view model better matches the image of the obstacle, so that the panoramic surround-view image finally displayed in the vehicle-mounted surround-view model may not be distorted.

According to an embodiment of the present disclosure, the present disclosure also provides a non-transitory computer readable storage medium storing computer instructions, the computer instructions, are used to cause the computer to perform the method for adjusting a vehicle-mounted surround-view model.

According to an embodiment of the present disclosure, the present disclosure also provides a computer program product, including a computer program, the computer program, when executed by a processor, implements the method for adjusting a vehicle-mounted surround-view model.

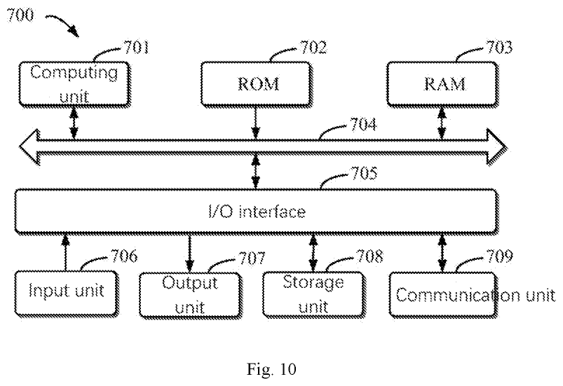

According to an embodiment of the present disclosure, the present disclosure also provides an electronic device. FIG. 10 shows a schematic block diagram of an example electronic device 700 that can be used to implement embodiments of the present disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile apparatuses, such as personal digital processors, cellular phones, smart phones, wearable devices, and other similar computing apparatuses. The components shown herein, their connections and relationships, and their functions are merely examples, and are not intended to limit the implementation of the present disclosure described and/or claimed herein.

As shown in FIG. 10, the device 700 includes a computing unit 701, which may perform various appropriate actions and processing, based on a computer program stored in a read-only memory (ROM) 702 or a computer program loaded from a storage unit 708 into a random access memory (RAM) 703. In the RAM 703, various programs and data required for the operation of the device 700 may also be stored. The computing unit 701, the ROM 702, and the RAM 703 are connected to each other through a bus 704. An input/output (I/O) interface 705 is also connected to the bus 704.

A plurality of components in the device 700 are connected to the I/O interface 705, including: an input unit 706, for example, a keyboard and a mouse; an output unit 707, for example, various types of displays and speakers; the storage unit 708, for example, a disk and an optical disk; and a communication unit 709, for example, a network card, a modem, or a wireless communication transceiver. The communication unit 709 allows the device 700 to exchange information/data with other devices over a computer network such as the Internet and/or various telecommunication networks.

The computing unit 701 may be various general-purpose and/or dedicated processing components having processing and computing capabilities. Some examples of the computing unit 701 include, but are not limited to, central processing unit (CPU), graphics processing unit (GPU), various dedicated artificial intelligence (AI) computing chips, various computing units running machine learning model algorithms, digital signal processors (DSP), and any appropriate processors, controllers, microcontrollers, etc. The computing unit 701 performs the various methods and processes described above, such as the method for adjusting a vehicle-mounted surround-view model. For example, in some embodiments, the method for adjusting a vehicle-mounted surround-view model may be implemented as a computer software program, which is tangibly included in a machine readable medium, such as the storage unit 708. In some embodiments, part or all of the computer program may be loaded and/or installed on the device 700 via the ROM 702 and/or the communication unit 709. When the computer program is loaded into the RAM 703 and executed by the computing unit 701, one or more steps of the method for adjusting a vehicle-mounted surround-view model described above may be performed. Alternatively, in other embodiments, the computing unit 701 may be configured to perform the method for adjusting a vehicle-mounted surround-view model by any other appropriate means (for example, by means of firmware).

The various implementations of the systems and technologies described herein can be implemented in digital electronic circuit systems, integrated circuit systems, field programmable gate arrays (FPGA), application-specific integrated circuits (ASIC), application-specific standard products (ASSP), system-on-chip (SOC), load programmable logic device (CPLD), computer hardware, firmware, software, and/or their combination. These various embodiments may include: being implemented in one or more computer programs, the one or more computer programs may be executed and/or interpreted on a programmable system including at least one programmable processor, the programmable processor can be a dedicated or general-purpose programmable processor that can receive data and instructions from the storage system, at least one input device, and at least one output device, and transmit the data and instructions to the storage system, the at least one input device, and the at least one output device.

The program code used to implement the method of the present disclosure can be written in any combination of one or more programming languages. These program codes can be provided to the processors or controllers of general-purpose computers, special-purpose computers, or other programmable data processing devices, so that when the program codes are executed by the processors or controllers, the functions/operations specified in the flowcharts and/or block diagrams are implemented. The program code can be executed entirely on a machine or partly executed on the machine, partly executed on the machine and partly executed on a remote machine as an independent software package, or entirely executed on a remote machine or server.

In the context of the present disclosure, a machine readable medium may be a tangible medium, which may contain or store a program for use by the instruction execution system, apparatus, or device or in combination with the instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, device, or apparatus, or any suitable combination of the foregoing. More specific examples of machine readable storage media may include electrical connections based on one or more wires, portable computer disks, hard drives, random access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

In order to provide interaction with a user, the systems and technologies described herein may be implemented on a computer, the computer has: a display apparatus (e.g., CRT (cathode ray tube) or LCD (liquid crystal display) monitor for displaying information to the user; and a keyboard and a pointing apparatus (for example, a mouse or trackball), the user may use the keyboard and the pointing apparatus to provide input to the computer. Other kinds of apparatuses may also be used to provide interaction with the user; for example, the feedback provided to the user may be any form of sensory feedback (for example, visual feedback, auditory feedback, or tactile feedback); and may use any form (including acoustic input, voice input, or tactile input) to receive input from the user.

The systems and technologies described herein may be implemented in a computing system (e.g., as a data server) that includes back-end components, or a computing system (e.g., an application server) that includes middleware components, or a computing system (for example, a user computer with a graphical user interface or a web browser, through which the user may interact with the embodiments of the systems and technologies described herein) that includes front-end components, or a computing system that includes any combination of such back-end components, middleware components, or front-end components. The components of the system may be interconnected by any form or medium of digital data communication (e.g., a communication network). Examples of the communication network include: local area network (LAN), wide area network (WAN), Internet, and blockchain network.

The computer system may include a client and a server. The client and the server are generally far from each other and usually interact through a communication network. The client and server relationship is generated by computer programs operating on the corresponding computer and having client-server relationship with each other. The server may be a cloud server, a distributed system server, or a server combined with blockchain.

It should be understood that various forms of processes shown above may be used to reorder, add, or delete steps. For example, the steps described in embodiments of the present disclosure may be performed in parallel, sequentially, or in different orders, as long as the desired results of the technical solution disclosed in the present disclosure can be achieved, no limitation is made herein.

The above specific embodiments do not constitute a limitation on the protection scope of the present disclosure. Those skilled in the art should understand that various modifications, combinations, sub-combinations and substitutions can be made according to design requirements and other factors. Any modification, equivalent replacement and improvement made within the spirit and principle of this disclosure shall be included in the protection scope of this disclosure.

What is claimed is:

1. A method for adjusting a vehicle-mounted surround-view model, the method comprising:
acquiring the vehicle-mounted surround-view model;
acquiring a lateral distance and a longitudinal distance between a vehicle and an obstacle; and
adjusting the vehicle-mounted surround-view model based on the lateral distance and the longitudinal distance.

2. The method according to claim 1, wherein, after the acquiring the vehicle-mounted surround-view model, the method further comprises:
acquiring a traveling speed of the vehicle, and determining whether the vehicle-mounted surround-view model needs to be adjusted based on the traveling speed.

3. The method according to claim 2, wherein determining whether the vehicle-mounted surround-view model needs to be adjusted based on the traveling speed comprises:
adjusting the vehicle-mounted surround-view model, if the traveling speed is greater than a preset threshold.

4. The method according to claim 1, wherein adjusting the vehicle-mounted surround-view model based on the lateral distance and the longitudinal distance comprises:
determining a lateral length and a longitudinal length of the adjusted vehicle-mounted surround-view model based on the lateral distance and the longitudinal distance.

5. The method according to claim 1, wherein, after adjusting the vehicle-mounted surround-view model, the method further comprises:
collecting a plurality of frames of images photographed by an image unit deployed on the vehicle, processing the plurality of frames of images to obtain a processed image, and displaying the processed image in the adjusted vehicle-mounted surround-view model.

6. The method according to claim 5, wherein processing the plurality of frames of images to obtain a processed image, and displaying the processed image in the adjusted vehicle-mounted surround-view model comprises:
performing distortion correction on each frame of image separately;
transforming distortion-corrected images into a bird's-eye top view plane through bird's-eye perspective transformation to obtain bird's-eye-transformed images; and
performing texture mapping, splicing and visual transformation of the bird's-eye-transformed images on the adjusted vehicle-mounted surround-view model to obtain a panoramic surround-view image, and displaying the panoramic surround-view image in the adjusted vehicle-mounted surround-view model.

7. An electronic device, comprising:
at least one processor; and
a memory communicatively connected to the at least one processor; wherein,
the memory stores instructions executable by the at least one processor, and the instructions, when executed by the at least one processor, cause the at least one processor to perform operations comprising:
acquiring the vehicle-mounted surround-view model;
acquiring a lateral distance and a longitudinal distance between a vehicle and an obstacle; and
adjusting the vehicle-mounted surround-view model based on the lateral distance and the longitudinal distance.

8. The electronic device according to claim 7, wherein, after the acquiring the vehicle-mounted surround-view model, the operations further comprise:
acquiring a traveling speed of the vehicle, and determining whether the vehicle-mounted surround-view model needs to be adjusted based on the traveling speed.

9. The electronic device according to claim 8, wherein determining whether the vehicle-mounted surround-view model needs to be adjusted based on the traveling speed comprises:
adjusting the vehicle-mounted surround-view model, if the traveling speed is greater than a preset threshold.

10. The electronic device according to claim 7, wherein adjusting the vehicle-mounted surround-view model based on the lateral distance and the longitudinal distance comprises:
determining a lateral length and a longitudinal length of the adjusted vehicle-mounted surround-view model based on the lateral distance and the longitudinal distance.

11. The electronic device according to claim 7, wherein, after adjusting the vehicle-mounted surround-view model, the operations further comprise:
collecting a plurality of frames of images photographed by an image unit deployed on the vehicle, processing the plurality of frames of images to obtain a processed image, and displaying the processed image in the adjusted vehicle-mounted surround-view model.

12. The electronic device according to claim 11, wherein processing the plurality of frames of images to obtain a processed image, and displaying the processed image in the adjusted vehicle-mounted surround-view model comprises:
performing distortion correction on each frame of image separately;
transforming distortion-corrected images into a bird's-eye top view plane through bird's-eye perspective transformation to obtain bird's-eye-transformed images; and
performing texture mapping, splicing and visual transformation of the bird's-eye-transformed images on the adjusted vehicle-mounted surround-view model to obtain a panoramic surround-view image, and displaying the panoramic surround-view image in the adjusted vehicle-mounted surround-view model.

13. A non-transitory computer readable storage medium storing computer instructions, wherein, the computer instructions when executed by a computer cause the computer to perform operations comprising:
acquiring the vehicle-mounted surround-view model;
acquiring a lateral distance and a longitudinal distance between a vehicle and an obstacle; and
adjusting the vehicle-mounted surround-view model based on the lateral distance and the longitudinal distance.

14. The storage medium according to claim 13, wherein, after the acquiring the vehicle-mounted surround-view model, the operations further comprise:
acquiring a traveling speed of the vehicle, and determining whether the vehicle-mounted surround-view model needs to be adjusted based on the traveling speed.

15. The storage medium according to claim 14, wherein determining whether the vehicle-mounted surround-view model needs to be adjusted based on the traveling speed comprises:
adjusting the vehicle-mounted surround-view model, if the traveling speed is greater than a preset threshold.

16. The storage medium according to claim 13, wherein adjusting the vehicle-mounted surround-view model based on the lateral distance and the longitudinal distance comprises:
determining a lateral length and a longitudinal length of the adjusted vehicle-mounted surround-view model based on the lateral distance and the longitudinal distance.

17. The storage medium according to claim 13, wherein, after adjusting the vehicle-mounted surround-view model, the operations further comprise:
collecting a plurality of frames of images photographed by an image unit deployed on the vehicle, processing the plurality of frames of images to obtain a processed image, and displaying the processed image in the adjusted vehicle-mounted surround-view model.

18. The storage medium according to claim 17, wherein processing the plurality of frames of images to obtain a processed image, and displaying the processed image in the adjusted vehicle-mounted surround-view model comprises:
performing distortion correction on each frame of image separately;
transforming distortion-corrected images into a bird's-eye top view plane through bird's-eye perspective transformation to obtain bird's-eye-transformed images; and
performing texture mapping, splicing and visual transformation of the bird's-eye-transformed images on the adjusted vehicle-mounted surround-view model to obtain a panoramic surround-view image, and displaying the panoramic surround-view image in the adjusted vehicle-mounted surround-view model.
